(19) United States
(12) Patent Application Publication
(10) Pub. No.: US 2007/0219861 A1
(43) Pub. Date: Sep. 20, 2007

(54) Personnel motivation model

(76) Inventor: Fred A. Cummins, Farmington Hills, MI (US)

Correspondence Address: Law Office of Stephen R. Loe, P.O. Box 649, Frisco, TX, 75034, US

(21) Appl. No.: 11/384,593

(22) Filed: Mar. 20, 2006

(51) Int. Cl. G06Q 30/00

(52) U.S. Cl. 705/14

(57) ABSTRACT

A method, system, tool, and computer program product for modeling human motivation within an enterprise thereby allowing a manager to properly design or change organizational structure, select personnel for projects, select goals, and consider values and relationships to design incentives to properly motivate individuals in order to achieve enterprise objectives. In one embodiment, the tool includes structurally monitoring and quantifying the effect of at least one incentive on the achievement of a goal in at least a plurality of individuals within the enterprise. The method and system structurally monitor and quantify the effect of community values, personal incentives or relationships on the achievement of a goal in at least a plurality of similarly situated individuals within the enterprise, as well as the effect of dependence on supporting goals on the achievement of a goal in at least a plurality of individuals within the enterprise.

### BACKGROUND OF THE INVENTION

1. Technical Field

The present invention relates generally to computer software and, more particularly, business methods, and, even more particularly, to tools for analysis of the motivation of personnel.

2. Description of Related Art

The design of an organization involves many factors. Strategic planning techniques develop consensus about the opportunities an enterprise should pursue and how the enterprise may need to change to realize the identified opportunities. Business planning activities define the interactions between business functions and support definition of business processes and organization structure. There are various forms of processes, techniques and models to support these efforts.

However, the success of the organization requires the participation and support of many people throughout the organization. Their motivation to contribute in an appropriate manner is crucial. While the planning activities may define objectives, goals and processes for the organization and its business units, typical consideration of the motivation of individuals is relatively superficial. Because motivation is complex, often subjective and dependent on many factors it is typically addressed as a secondary issue after other decisions about the organization structure and processes are already made on the basis of intuition regarding the appropriateness of roles and responsibilities.

In recent years, motivation has become an increasingly important factor in the success of an enterprise. Employees are more independent in their thinking and their ability to obtain employment elsewhere. Many give much more weight to personal values than in the past. Job responsibilities rely more on judgment and initiative rather than prescribed procedures and rules.

In the current, Internet-driven, highly competitive, global economy, an enterprise must achieve a high level of productivity, innovation and responsiveness, requiring employee efforts to be motivated to support the enterprise goals where they may have been more focused on local, sub-optimal goals in the past. Employees must act on their own initiative with minimal supervision in order to act quickly, deal appropriately with complex problems and make effective use of their individual talents and expertise.

Consequently, it is important to provide enterprise managers with a tool to assist in analyzing and designing a system of incentives to properly motivate the personnel to achieve the objectives of the enterprise.

### SUMMARY OF THE INVENTION

The present invention provides a personnel motivation tool for aiding personnel managers in considering values and relationships while designing a system of incentives to properly motivate the personnel in an enterprise in order to achieve the objectives of the enterprise. The tool also aids a manager in designing or changing the organizational structure of the enterprise, picking people differently for assignments, or assigning goals to different organizations to achieve the objectives of the enterprise. Furthermore, the tool allows a manager to decide whether a goal is even achievable and therefore modify or eliminate unrealizable goals. In one embodiment, the tool comprises goal units, motivations units, incentive units and job role units that quantify incentives and motivations for individual personnel. A person (in a role) responds to incentives (which may be applicable to many roles) according to motivations that encourage or discourage achievement of goals. The motivation may be dependent on the characteristics of persons in the role, the incentive, and the goal. This basic model is extended by incorporating the influence of other persons (e.g., a manger), values associated with membership in communities, and dependence on others to achieve supporting goals. The data is then presented to a manager allowing the manager to see what factors influence various personnel thereby enabling the manager to consider values and relationships in order to tailor incentives of the various individuals within an enterprise as well as to design or change organizational structure, choose appropriate personnel for projects, and to choose and assign goals in order to more efficiently achieve enterprise objectives.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2A depicts a block diagram of a data processing system which may be implemented as a server in accordance with one embodiment of the present invention;

FIG. 2B depicts a block diagram of a data processing system in which the present invention may be implemented;

FIG. 3A depicts a block diagram illustrating the relationship of software components operating within a computer system that may implement the present invention;

FIG. 3B depicts a block diagram of a JVM in accordance with a one embodiment of the present invention;

FIG. 4 illustrates a meta model for the motivation model in accordance with one embodiment of the present invention; and

FIG. 5 illustrates one visual presentation of an abstraction of the motivation model in accordance with one embodiment of the present invention.

### DETAILED DESCRIPTION OF THE PREFERRED EMBODIMENT

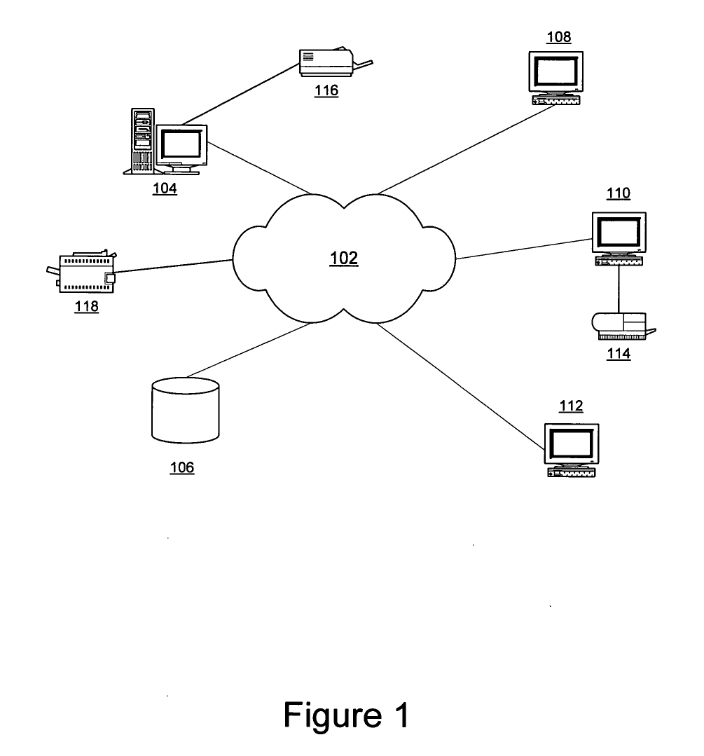

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections.

In the depicted example, server 104 is connected to network 102, along with storage unit 106. In addition, clients 108, 110 and 112 are also connected to network 102. These clients, 108, 110 and 112, may be, for example, personal computers or network computers. For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. Of course, distributed data processing system 100 also may be implemented as a number of different types of networks such as, for example, an intranet or a local area network.

FIG. 1 is intended as an example and not as an architectural limitation for the processes of the present invention.

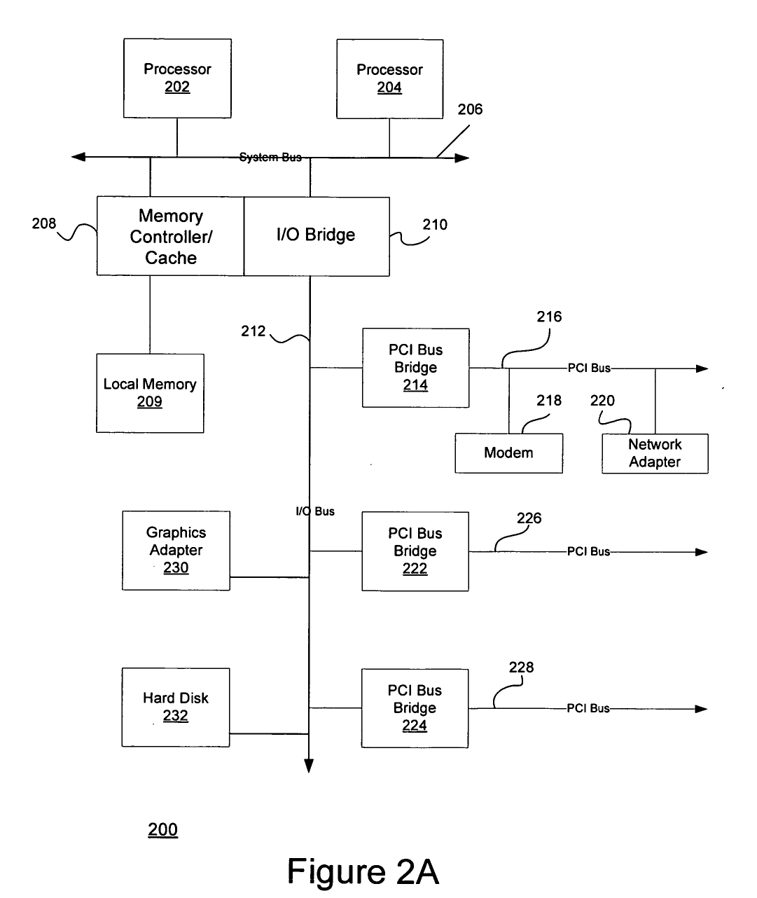

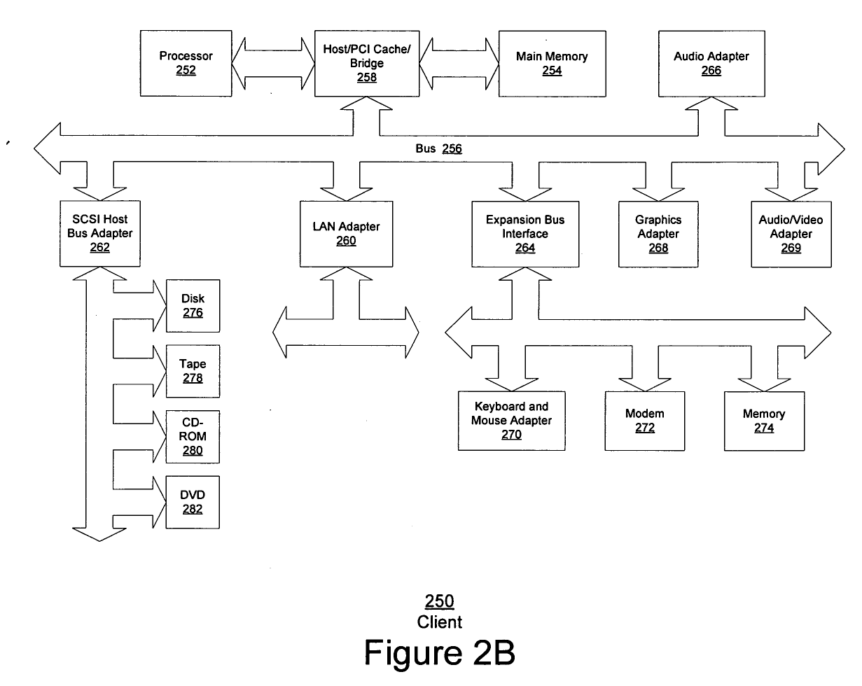

With reference now to FIG. 2A, a block diagram of a data processing system which may be implemented as a server, such as server 104 in FIG. 1, is depicted in accordance with one embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O Bus Bridge 210 is connected to system bus 206 and provides an interface to I/O bus 212. Memory controller/cache 208 and I/O Bus Bridge 210 may be integrated as depicted.

Peripheral component interconnect (PCI) bus bridge 214 connected to I/O bus 212 provides an interface to PCI local bus 216. A modem 218 may be connected to PCI local bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2A may vary. For example, other peripheral devices, such as optical disk drive and the like also may be used in addition or in place of the hardware depicted. The depicted example is not meant to imply architectural limitations with respect to the present invention.

The data processing system depicted in FIG. 2A may be, for example, an IBM RISC/System 6000 system, a product of International Business Machines Corporation in Armonk, New York, running the Advanced Interactive Executive (AIX) operating system.

With reference now to FIG. 2B, a block diagram of a data processing system in which the present invention may be implemented is illustrated. Data processing system 250 is an example of a client computer. Data processing system 250 employs a peripheral component interconnect (PCI) local bus architecture. Although the depicted example employs a PCI bus, other bus architectures such as Micro Channel and ISA may be used. Processor 252 and main memory 254 are connected to PCI local bus 256 through PCI Bridge 258. PCI Bridge 258 also may include an integrated memory controller and cache memory for processor 252. Additional connections to PCI local bus 256 may be made through direct component interconnection or through add-in boards. In the depicted example, local area network (LAN) adapter 260, SCSI host bus adapter 262, and expansion bus interface 264 are connected to PCI local bus 256 by direct component connection. In contrast, audio adapter 266, graphics adapter 268, and audio/video adapter (A/V) 269 are connected to PCI local bus 266 by add-in boards inserted into expansion slots. Expansion bus interface 264 provides a connection for a keyboard and mouse adapter 270, modem 272, and additional memory 274. SCSI host bus adapter 262 provides a connection for hard disk drive 276, tape drive 278, and CD-ROM 280 in the depicted example. Typical PCI local bus implementations will support three or four PCI expansion slots or add-in connectors.

An operating system runs on processor 252 and is used to coordinate and provide control of various components within data processing system 250 in FIG. 2B. The operating system may be a commercially available operating system such as JavaOS For Business™ or OS/2™, which are available from International Business Machines Corporation™. JavaOS is loaded from a server on a network to a network client and supports Java programs and applets. A couple of characteristics of JavaOS that are favorable for performing traces with stack unwinds, as described below, are that JavaOS does not support paging or virtual memory. An object oriented programming system such as Java may run in conjunction with the operating system and may provide calls to the operating system from Java programs or applications executing on data processing system 250. Instructions for the operating system, the object-oriented operating system, and applications or programs are located on storage devices, such as hard disk drive 276 and may be loaded into main memory 254 for execution by processor 252. Hard disk drives are often absent and memory is constrained when data processing system 250 is used as a network client.

Those of ordinary skill in the art will appreciate that the hardware in FIG. 2B may vary depending on the implementation. For example, other peripheral devices, such as optical disk drives and the like may be used in addition to or in place of the hardware depicted in FIG. 2B. The depicted example is not meant to imply architectural limitations with respect to the present invention. For example, the processes of the present invention may be applied to a multiprocessor data processing system.

Before embarking on a more detailed description of the present invention, a brief overview of object oriented technology and programming is provided for those unfamiliar with these concepts.

Object oriented technology is a methodology for designing and programming information systems. Object technology differs from traditional system design which separates the data from the processing. Although data and processing are naturally related since software causes the computer to process data, the traditional approach has been to design the databases separate and apart from the processing routines, often using different modeling and documentation tools.

In object technology, which is implemented using object-oriented programming tools, information systems are designed as building blocks that contain both the data and the processing (the “attributes” and the “methods”). For example, a customer object would contain customer data (name, address, etc.) and the kinds of processing that would take place for a customer (place order, request information, etc.) would also be built into the object.

Object Oriented Programming, often abbreviated as “OOP,” is programming that supports object technology. It is an evolutionary form of modular programming with more formal rules that allow pieces of software to be reused and interchanged between programs. Major concepts are encapsulation, inheritance and polymorphism.

Encapsulation is the creation of self-sufficient modules that contain the data and the processing (data structure and functions that manipulate that data). These user-defined, or abstract, data types are called “classes.” One instance of a class is called an “object.” For example, in a payroll system, a class could be defined as Manager, and Pat and Jan, the actual objects, are instances of that class.

Classes are created in hierarchies, and inheritance allows the knowledge in one class to be passed down the hierarchy. That means less programming is required when adding functions to complex systems. If a step is added at the bottom of a hierarchy, then only the processing and data associated with that unique step needs to be added. Everything else about that step is inherited.

Object-oriented programming allows procedures about objects to be created whose exact type is not known until runtime. For example, a screen cursor may change its shape from an arrow to a line depending on the program mode. The routine to move the cursor on screen in response to mouse movement would be written for “cursor,” and polymorphism would allow that cursor to be whatever shape is required at runtime. It would also allow a new shape to be easily integrated into the program. Returning now to the present invention

The present invention provides a process and system for a tool to assist managers in creating and/or changing organizational structure, selecting goals, choosing personnel for projects, and motivating employees or other personnel in order to more efficiently achieve enterprise objectives and may be implemented in an object oriented programming environment, such as, for example, Java. However, the present invention is not limited to implementation in an object oriented environment, but may be implemented in any number of data processing environments and as such, the present invention is not limited to object oriented systems, but is merely described in such an environment for exemplary purposes.

Thus, although the present invention may operate on a variety of computer platforms and operating systems, it may also operate within a Java runtime environment. Hence, the present invention may operate in conjunction with a Java virtual machine (JVM) yet within the boundaries of a JVM as defined by Java standard specifications. In order to provide a context for the present invention, portions of the operation of a JVM according to Java specifications are herein described.

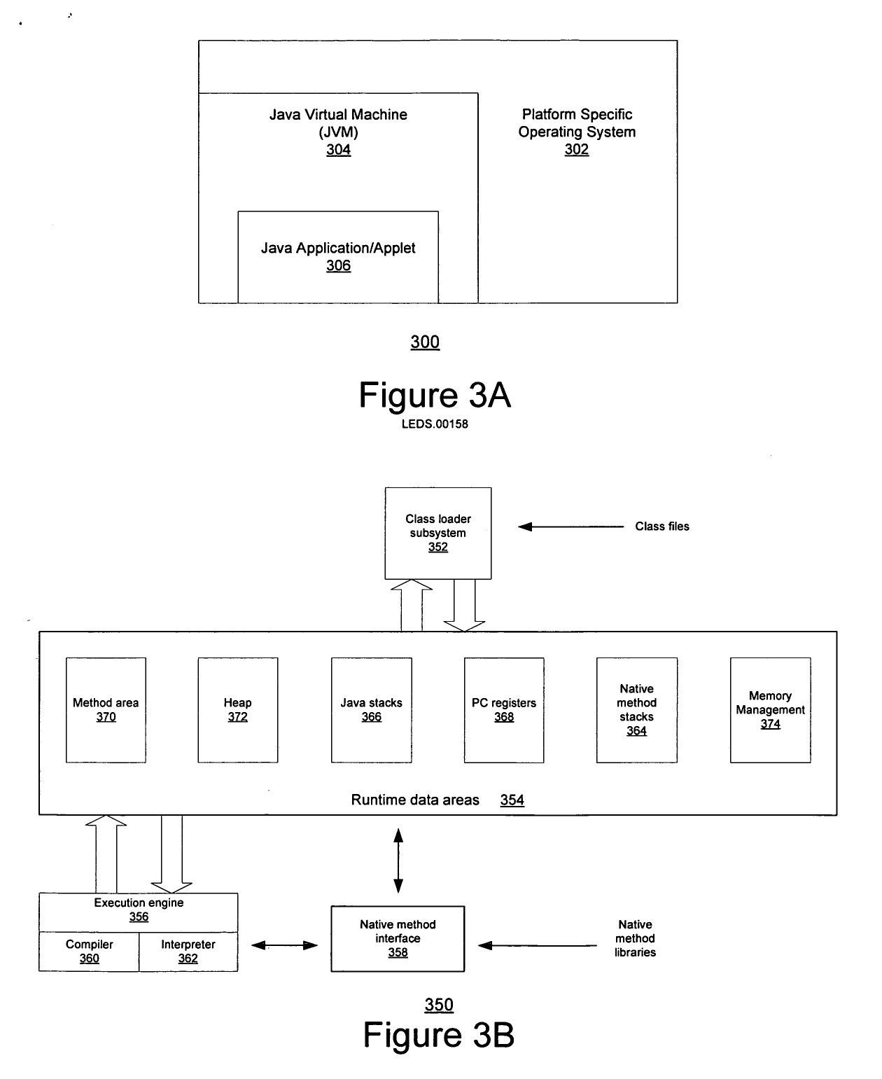

With reference now to FIG. 3A, a block diagram illustrates the relationship of software components operating within a computer system that may implement the present invention. Java-based system 300 contains platform specific operating system 302 that provides hardware and system support to software executing on a specific hardware platform. JVM 304 is one software application that may execute in conjunction with the operating system. JVM 304 provides a Java run-time environment with the ability to execute Java application or applet 306, which is a program, servlet, or software component written in the Java programming language. The computer system in which JVM 304 operates may be similar to data processing system 200 or computer 100 described above. However, JVM 304 may be implemented in dedicated hardware on a so-called Java chip, Java-on-silicon, or Java processor with an embedded picoJava core.

At the center of a Java run-time environment is the JVM, which supports all aspects of Java's environment, including its architecture, security features, mobility across networks, and platform independence.

The JVM is a virtual computer, i.e. a computer that is specified abstractly. The specification defines certain features that every JVM must implement, with some range of design choices that may depend upon the platform on which the JVM is designed to execute. For example, all JVMs must execute Java bytecodes and may use a range of techniques to execute the instructions represented by the bytecodes. A JVM may be implemented completely in software or somewhat in hardware. This flexibility allows different JVMs to be designed for mainframe computers and PDAs.

The JVM is the name of a virtual computer component that actually executes Java programs. Java programs are not run directly by the central processor but instead by the JVM, which is itself a piece of software running on the processor. The JVM allows Java programs to be executed on a different platform as opposed to only the one platform for which the code was compiled. Java programs are compiled for the JVM. In this manner, Java is able to support applications for many types of data processing systems, which may contain a variety of central processing units and operating systems architectures. To enable a Java application to execute on different types of data processing systems, a compiler typically generates an architecture-neutral file format—the compiled code is executable on many processors, given the presence of the Java run-time system. The Java compiler generates bytecode instructions that are nonspecific to a particular computer architecture. A bytecode is a machine independent code generated by the Java compiler and executed by a Java interpreter. A Java interpreter is part of the JVM that alternately decodes and interprets a bytecode or bytecodes. These bytecode instructions are designed to be easy to interpret on any computer and easily translated on the fly into native machine code. Byte codes are may be translated into native code by a just-in-time compiler or JIT.

A JVM must load class files and execute the bytecodes within them. The JVM contains a class loader, which loads class files from an application and the class files from the Java application programming interfaces (APIs) which are needed by the application. The execution engine that executes the bytecodes may vary across platforms and implementations.

One type of software-based execution engine is a just-in-time compiler. With this type of execution, the bytecodes of a method are compiled to native machine code upon successful fulfillment of some type of criteria for jitting a method. The native machine code for the method is then cached and reused upon the next invocation of the method. The execution engine may also be implemented in hardware and embedded on a chip so that the Java bytecodes are executed natively. JVMs usually interpret bytecodes, but JVMs may also use other techniques, such as just-in-time compiling, to execute bytecodes.

Interpreting code provides an additional benefit. Rather than instrumenting the Java source code, the interpreter may be instrumented. Trace data may be generated via selected events and timers through the instrumented interpreter without modifying the source code. Profile instrumentation is discussed in more detail further below.

When an application is executed on a JVM that is implemented in software on a platform-specific operating system, a Java application may interact with the host operating system by invoking native methods. A Java method is written in the Java language, compiled to bytecodes, and stored in class files. A native method is written in some other language and compiled to the native machine code of a particular processor. Native methods are stored in a dynamically linked library whose exact form is platform specific.

With reference now to FIG. 3B, a block diagram of a JVM is depicted in accordance with a preferred embodiment of the present invention. JVM 350 includes a class loader subsystem 352, which is a mechanism for loading types, such as classes and interfaces, given fully qualified names. JVM 350 also contains runtime data areas 354, execution engine 356, native method interface 358, and memory management 374. Execution engine 356 is a mechanism for executing instructions contained in the methods of classes loaded by class loader subsystem 352. Execution engine 356 may be, for example, Java interpreter 362 or just-in-time compiler 360. Native method interface 358 allows access to resources in the underlying operating system. Native method interface 358 may be, for example, a Java native interface.

Runtime data areas 354 contain native method stacks 364, Java stacks 366, PC registers 368, method area 370, and heap 372. These different data areas represent the organization of memory needed by JVM 350 to execute a program.

Java stacks 366 are used to store the state of Java method invocations. When a new thread is launched, the JVM creates a new Java stack for the thread. The JVM performs only two operations directly on Java stacks: it pushes and pops frames. A thread's Java stack stores the state of Java method invocations for the thread. The state of a Java method invocation includes its local variables, the parameters with which it was invoked, its return value, if any, and intermediate calculations. Java stacks are composed of stack frames. A stack frame contains the state of a single Java method invocation. When a thread invokes a method, the JVM pushes a new frame onto the Java stack of the thread. When the method completes, the JVM pops the frame for that method and discards it. The JVM does not have any registers for holding intermediate values; any Java instruction that requires or produces an intermediate value uses the stack for holding the intermediate values. In this manner, the Java instruction set is well-defined for a variety of platform architectures.

PC registers 368 are used to indicate the next instruction to be executed. Each instantiated thread gets its own pc register (program counter) and Java stack. If the thread is executing a JVM method, the value of the pc register indicates the next instruction to execute. If the thread is executing a native method, then the contents of the pc register are undefined.

Native method stacks 364 store the state of invocations of native methods. The state of native method invocations is stored in an implementation-dependent way in native method stacks, registers, or other implementation-dependent memory areas. In some JVM implementations, native method stacks 364 and Java stacks 366 are combined.

Method area 370 contains class data while heap 372 contains all instantiated objects. The JVM specification strictly defines data types and operations. Most JVMs choose to have one method area and one heap, each of which are shared by all threads running inside the JVM. When the JVM loads a class file, it parses information about a type from the binary data contained in the class file. It places this type information into the method area. Each time a class instance or array is created, the memory for the new object is allocated from heap 372. JVM 350 includes an instruction that allocates memory space within the memory for heap 372 but includes no instruction for freeing that space within the memory. Memory management 374 in the depicted example manages memory space within the memory allocated to heap 370. Memory management 374 may include a garbage collector which automatically reclaims memory used by objects that are no longer referenced. Additionally, a garbage collector also may move objects to reduce heap fragmentation.

The processes within the following figures provide an overall perspective of the many processes employed within the present invention: processes that provide a personnel motivation model.

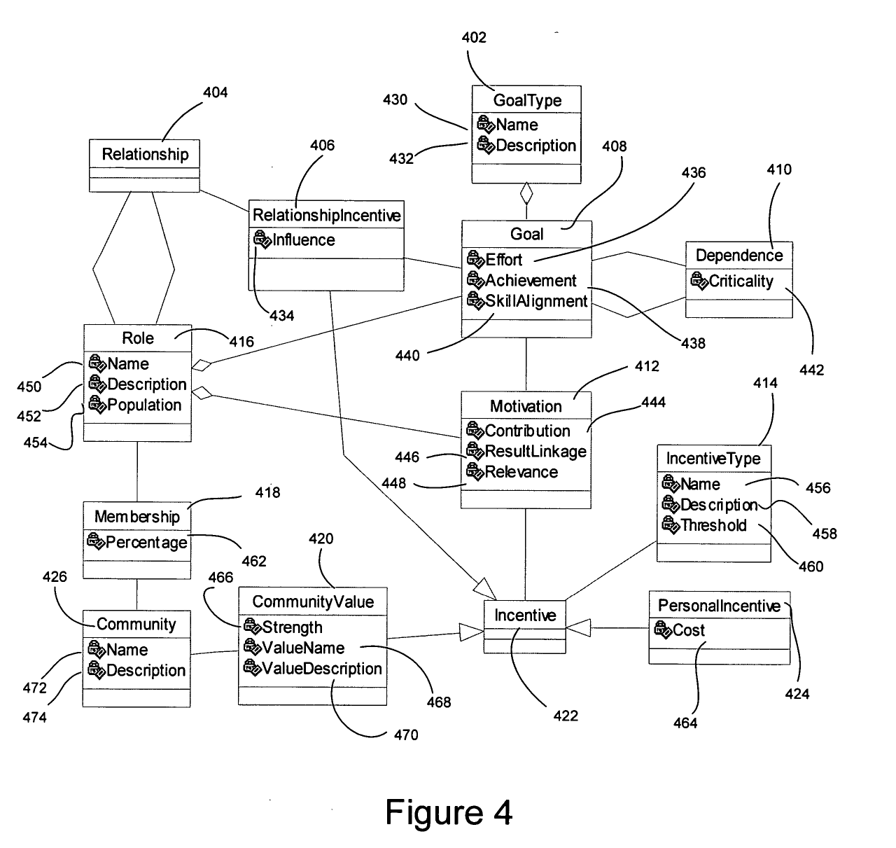

FIG. 4 illustrates a meta model (a model of the modeling element objects) for the motivation model in accordance with one embodiment of the present invention. The core model is based on goals, motivations, incentives and job roles. A person (in a role) responds to incentives (which may be applicable to many roles) according to motivations that encourage or discourage achievement of goals. The motivation may be dependent on the characteristics of persons in the role, the incentive, and the goal. This basic model is extended by incorporating the influence of other persons (e.g., a manger), values associated with membership in communities, and dependence on others to achieve supporting goals. These and related elements are described in some detail, in the following paragraphs.

GoalType 402. A goal type 402 specifies a goal that may apply to a number of roles. This provides a common point of definition so that the name and description are used consistently and need not be repeated.

Name 430. A brief name 430 for reference.

Description 432. A description 432 that expresses the nature of the goal.

Goal 408. A goal 408 is a result to be achieved by a person performing in a particular role in the organization. Goals 408 are not specific to individuals, but rather for all people in a role, i.e., doing similar kinds of work in similar circumstances. These are goals perceived by persons in the role; and the objective of modeling is to ensure that these persons have appropriate incentives to achieve goals that are aligned with enterprise goals 408. The Goal object 408 will capture the likelihood of success (Achievement) 438 for the people in the associated role. A different role will require a different Goal object 408. A goal incorporates the name 430 and description 432 of its associated GoalType 402 and may have the following attributes.

Effort 436. An indication of the level of effort required of the individual to achieve the goal.

Achievement 438. An indication of the likelihood of success given the associated motivations.

SkillAlignment 440. The extent to which the individuals' skills are consistent with the requirements of achieving the goal.

Motivation 412. Motivation 412 captures the relevant information for the linkage between an incentive and a goal for an individual in the associated role. Motivation 412 will describe how an incentive may encourage or discourage achievement of the goal 408. It also describes how goal success is linked to the incentive, e.g., the person may receive a reward if the goal is achieved, and the level of reward may be linked to the level of success. The following attributes may be used to describe the nature of the motivation.

Contribution 444. An indication of the significance of the motivation with respect to the goal. This may be positive or negative. This factor will be a consequence of the significance of the incentive to the individual, and the attributes of the goal (e.g., the individual's perception of the effort and opportunity for success).

ResultLinkage 446. The manner in which the incentive is linked to the achievement of the goal.

Relevance 448. An indication of the relevance of the incentive to the associated goal. For example, if incentive pay is provided for producing a specified result, then the goal associated with achieving that result is the targeted goal. Other motivation for achieving other goals may also be affected as side effects.

Incentive 422. An Incentive 422 is a factor that influences a person's behavior. An Incentive 422 may be of three forms, discussed below: personal incentive 424, community value 420 and relationship incentive 406. The associated Motivations 412 define the effects of an Incentive 422 in different goals. The attributes of incentives 422 are incorporated from the associated IncentiveType 414.

IncentiveType 414. The same IncentiveType 414 may apply to different roles in different ways and may be used to achieve different goals. The IncentiveType 414 provides characteristics that are the same across different roles. A tool might provide a list of potential incentive types and enable the user to selectively insert incentives for a particular role. An IncentiveType 414 has the following attributes:

Name 456. A short name for reference and identification in displays.

Description 458. A textual description of the nature of the incentive.

Threshold 460. Specification of a threshold for the incentive indicating that the incentive must exceed the threshold to be effective.

Role 416. A Role 416 defines a group of people that perform a particular function in a particular context within the organization. The job role may be very specific to an organizational unit, or it may describe many people doing similar jobs in different organizational units depending on the level of detail desired in the resulting model. A Role 416 object may describe a job function of individual performers, or it may describe the responsibility of a manager. For a manager, the goals may be individual or may be associated with the organization the manager manages such that they become relationship goals for the manager's subordinates.

A role 416 includes the following attributes:

Name 450. A name for reference to the role.

Description 452. A description of the nature of the role such as the job function or skill set of the persons in that role.

Population 454. The number of persons in the role.

A tool might provide automated mechanisms to help transform a general role into multiple, more specific roles when a more detailed analysis is desired.

CommunityValue 420. A community value is an incentive experienced by members of a community or group of individuals. For example, a community of physicians may be influenced by their code of ethics. A community may have several relevant values. A person may be a member of multiple communities. A project team might also be considered a community. People in a particular role may include members and non-members of several communities. The associated motivation will define how these people will be encouraged or discouraged to achieve the associated goal as a result of their community membership. A community value 420 may have an associated “Strength” attribute 466:

Strength 466. The strength of influence of the community value on members of the community.

ValueName 468. A brief name for reference.

ValueDescription 470. A description of the value.

PersonalIncentive 424. A personal incentive 424 is an incentive that has a direct influence on the behavior of individuals in the associated role. For example, it includes salary and incentive pay. A personal incentive may have the following attribute in addition to those incorporated from its associated IncentiveType 414:

Cost 464. The cost of the incentive to the enterprise.

RelationshipIncentive 406. This incentive 406 is the result of a relationship 404 with another person in a different role such as a supervisor, project leader or co-worker. Relationships 404 might also be based on collaboration groups, or other disciplines of a team. The RelationshipIncentive 406 is linked to a goal of the related person which may or may not be aligned with goals of the subject person. These incentives are of interest where they have a particular impact on the behavior of the subject person and are not the same as a goal otherwise assigned to the subject person. This incentive 406 has the following attribute:

Influence 434. An indication of the level of influence the related person has on the behavior of the subject person.

Membership 418. Membership links a role to a community. The Membership link indicates the percentage of persons in the role who are members of the associated community. It has the following attribute:

Percentage 462. The percent of the persons in the defined role that are members of the community.

Community 426. A group with common values where the values may have an influence on the behavior of a member in a particular role. The community value becomes an incentive for the person in the role. Since different persons in a role may be members of different communities, these values may cause different persons in a role to be more or less motivated to achieve certain goals. The Community will include the following attributes:

Name 472. A name for reference.

Description 474. A description of the distinguishing characteristics of members of the community and the nature of the community that may influence their behavior.

Dependence 410. This link defines the association between a goal and a supporting goal associated with a different role. This will typically occur where a person in one role depends on others for support or to perform related tasks. Thus the goals of a process performed by a person in one role may rely on sub-processes performed by others.

Criticality 442. The Criticality attribute identifies how critical the supporting goal is to the subject goal.

This model provides a structure for analysis of goals, incentives and motivation. As described, the analysis is based on subjective values of incentives, measures of motivation and probability of success of goals. These may be refined through experience with the model. In addition, more quantitative and more objective measures may be developed through empirical studies of values, behavior and achievement of goals. The attributes on these model elements are a starting point to provide an understanding of the model. Additional attributes may be added to provide additional insights for the analyst and to document the considerations that the analyst used in drawing particular conclusions.

The model may be linked to an analysis of business processes and organization where the objectives of processes and organizations become goals in this analysis.

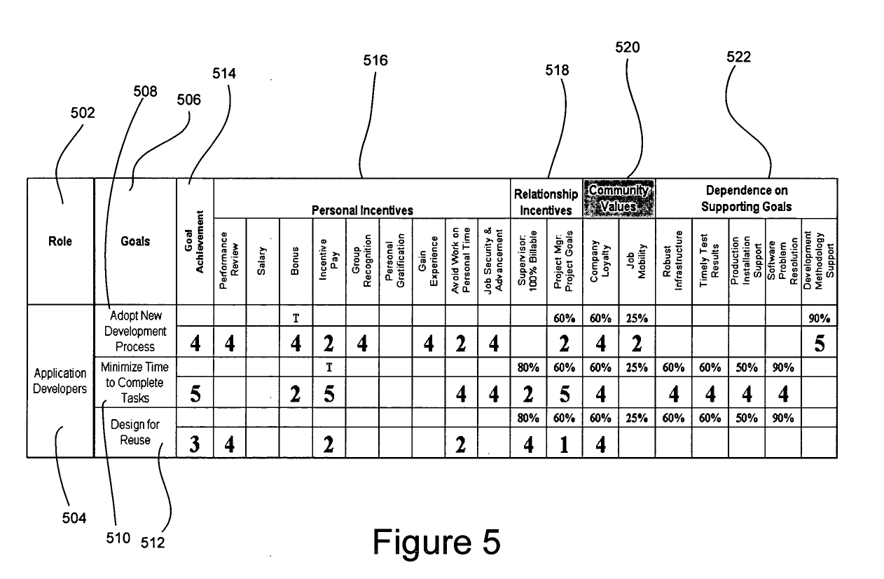

FIG. 5 illustrates one visual presentation of an abstraction of the motivation model (i.e., it does not include all of the potential information) in accordance with one embodiment of the present invention. This tabular representation shows incentives 516 and 518, goals 506 and motivations for a particular role 502: “application developers 504.” Three goal types 506 are represented: (1) adopt a new development process 508, (2) minimize time to complete tasks 510 and (3) design for reuse 512.

Each motivation, the intersection of a goal row 508, 510, and 512 and an incentive column (columns beneath personal incentives 516 and relationship incentives 518), indicates the relevance of the incentive and the influence it has on the goal. In this example, motivations have been given values from 1 to 5 where 1 is strongly opposed, 2 is somewhat opposed, 3 is neutral, 4 is somewhat supportive and 5 is strongly supportive. Motivations with a value of 3 have been left blank to highlight the others. The smaller box at each intersection indicates relevance, and the form varies depending on the category of column.

There are three categories of incentives: personal incentives 516, relationship incentives 518 and community values 520 (three of the column groups). The fourth group of columns 522 describes dependence on other roles and is discussed later.

Personal incentives 516 have a direct impact on the individual. A “T” indicates where an incentive is targeted for the goal. Presenting a list of potential incentives provides the analyst with a checklist to consider motivations. The motivation is indicated in the matrix with a value of 1 to 5 (blank for 3) where an impact is expected. The Goal Impact column indicates the overall impact on the goal. The illustration has used integer values for simplicity, but fractional values could be used or some other scale could be used.

The incentive pay column illustrates an incentive that is targeted for the second goal but has an impact on the other goals. In this case, the incentive pay to minimize time to complete tasks has a negative effect on adopting a new development process and designing for reuse. Similarly, the incentive to avoid work on personal time has a positive effect on minimizing time to complete tasks, but a negative effect on the other two goals that imply additional work.

Relationship incentives 518 are derived from relationships-in this case, relationships with a supervisor and a project manager. The supervisor incentive is only considered relevant to the second and third goals, but it is expected to influence the behavior of developers 80% of the time for those goals. The project manager incentive applies to all three goals but is negative with respect to the first and third goals and positive with respect to the second. The project manager has less influence than the supervisor (60%).

Some developers are considered to be members of one or both of the two communities. These communities have values that result in company loyalty as a potential incentive and job mobility as a potential disincentive. The associated percentages in the goal rows represent the proportion of the developers who are influenced by those views.

The columns under “Dependence on Supporting Goals” represent goals 522 to be achieved by other roles. Within this group, the percentages indicate the level of dependence on the supporting goal, and the numeric values indicate the level of achievement of the supporting goal by the other role. Thus the achievement of supporting goals can be factored into the achievement of the goals of the subject role. A modeling tool might enable the user to navigate from the supporting goal in this table to the associated table for the supporting role to gain an understanding of the incentives to achieve that goal. It might also provide a linkage from a goal of a role to the other roles that depend on achievement of that goal.

Considerably more information can be associated with these elements as indicated in the object model, presented earlier. This information might be presented in other views or made available through other techniques such as pop-up notes that appear when the cursor is moved over the associated element.

A more sophisticated and potentially automated analysis could be performed with empirical values assigned to motivations and other factors, along with a computation for goal achievement 514. The metrics might be developed from studies of employee attitudes and actual improved achievement of goals in response to incentives. One goal of the model is to provide a framework for analysis.

To aid the Patent Office, and any readers of any patent issued on this application in interpreting the claims appended hereto, it is noted that applicant does not intend any of the appended claims to invoke paragraph 6 of 35 U.S.C. § 112 as it exists on the date of filing unless the words “means for” are used in the particular claim. Furthermore, none of the description in the present application should be read as implying that any particular element, step, or function is an essential element which must be included in the claim scope: THE SCOPE OF THE PATENTED SUBJECT MATTER IS DEFINED ONLY BY THE ALLOWED CLAIMS. Thus, the extent of legal protection will be determined by the limitations recited in the allowed claims and their equivalents. Unless explicitly recited, other aspects of the present invention as described in this specification do not limit the scope of the claims.

As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A personnel motivation tool for aiding personnel managers in creating or changing organizational structure, selecting personnel for projects, determining goals, and considering values and relationships in designing a system of incentives to properly motivate the personnel in order to achieve the objectives of the enterprise, the personnel motivation tool comprising:
a goal unit for defining a result to be achieved by a person performing a particular role in the enterprise;
a role unit that defines a group of people that perform a particular function in a particular context within the enterprise;
a motivation unit for capturing the relevant information for the linkage between an incentive and a goal for an individual in the associated role; and
an incentive unit that contains a factor that influences a person's behavior.

2. The personnel motivation tool as recited in claim 1, wherein the incentive unit comprises a personal incentive unit that comprises an incentive that has a direct influence on the behavior of individuals in the associated role.

3. The personnel motivation tool as recited in claim 1, wherein the incentive unit comprises a community value unit that comprises an incentive experienced by members of a group of individuals.

4. The personnel motivation tool as recited in claim 1, wherein the incentive unit comprises a relationship incentive unit that is an incentive that is the result of a relationship between a person in the subject role and a person in a related role within the enterprise.

5. The personnel motivation tool as recited in claim 4, wherein the relationship incentive unit comprises an influence unit that provides an indication of the level of influence that a related person has on the behavior of the subject person.

6. The personnel motivation tool as recited in claim 1, further comprising:
a dependence unit that defines the association between a goal and a supporting goal associated with a different role.

7. The personnel motivation tool as recited in claim 1, further comprising:
a goal type unit that specifies a goal that may apply to a number of roles.

8. The personnel motivation tool as recited in claim 1, wherein the goal unit comprises at least one of an effort attribute that provides an indication of the level of effort required of the individual to achieve the goal, an achievement attribute that contains an indication of the likelihood of success given the associated motivations, and a skill alignment attribute that contains an assessment of the extent to which the individuals' skills are consistent with the requirements of achieving the goal.

9. The personnel motivation tool as recited in claim 1, wherein the motivation unit comprises at least one of a contribution attribute that contains an indication of the significance of the motivation with respect to the goal, a result linkage attribute that contains the manner in which the incentive is linked to the achievement of the goal, and a relevance attribute that contains an indication of the relevance of the incentive to the associated goal.

10. The personnel motivation tool as recited in claim 1, further comprising:
a membership unit that links a role to a community.

11. The personnel motivation tool as recited in claim 1, further comprising:
a community unit that contains the name and description of a group with common values where the values may have an influence on the behavior of a member in a particular role.

12. The personnel motivation tool as recited in claim 1, further comprising:
a membership unit that links a role to a community wherein the membership unit comprises a percentage attribute that indicates the percent of the persons in the defined role that are members of the community.

13. The personnel motivation tool as recited in claim 1, further comprising:
a community value unit that is an incentive experienced by one of members of a community and a group of individuals wherein the community value unit comprises a strength attribute that indicates the strength of influence of the community value on members of the community.

14. The personnel motivation tool as recited in claim 1, further comprising:
an incentivetype unit that provides characteristics for an incentive that are the same across different roles wherein the incentivetype unit comprises a threshold attribute that indicates a threshold for the incentive indicating that the incentive must exceed the threshold to be effective

15. A method for modeling human motivation within an enterprise, the method comprising:
structurally monitoring and measuring the effect of at least one incentive on the achievement of a goal in at least a plurality of individuals within the enterprise;
structurally monitoring and measuring the effect of community values on the achievement of a goal in at least a plurality of individuals within the enterprise;
structurally monitoring and measuring the effect of dependence on supporting goals on the achievement of a goal in at least a plurality of individuals within the enterprise; and
modifying the application of said personal incentives, said relationship incentives, and said community values in response to results deriving from said structurally monitoring and measuring steps.

16. The method of claim 15, further comprising:
structurally monitoring and measuring the effect of at least one personal incentive on the achievement of a goal in at least a plurality of individuals within the enterprise.

17. The method of claim 15, further comprising
structurally monitoring and measuring the effect of at least one relationship incentive on the achievement of a goal in at least a plurality of individuals within the enterprise.

18. The method of claim 15, further comprising:
structurally monitoring and measuring the effect of at least one personal incentive on the achievement of a goal in at least a plurality of individuals within the enterprise relative to a predetermined role associated said plurality of individuals.

19. The method of claim 15, further comprising:
structurally monitoring and measuring the effect of at least one relationship incentive on the achievement of a goal in at least a plurality of individuals within the enterprise relative to a predetermined role associated said plurality of individuals.

20. A computer program product in a computer readable media for use in a data processing system for modeling human motivation within an enterprise, the computer program product comprising:
first instructions for structurally monitoring and measuring the effect of at least one incentive on the achievement of a goal in at least a plurality of individuals within the enterprise;
second instructions for structurally monitoring and measuring the effect of community values on the achievement of a goal in at least a plurality of individuals within the enterprise;
third instructions for structurally monitoring and measuring the effect of dependence on supporting goals on the achievement of a goal in at least a plurality of individuals within the enterprise; and
fourth instructions for modifying the application of said personal incentives, said relationship incentives, and said community values in response to results deriving from said structurally monitoring and measuring steps.

21. A system for modeling human motivation within an enterprise, the system comprising:
first means for structurally monitoring and measuring the effect of at least one incentive on the achievement of a goal in at least a plurality of individuals within the enterprise;
second means for structurally monitoring and measuring the effect of community values on the achievement of a goal in at least a plurality of individuals within the enterprise;
third means for structurally monitoring and measuring the effect of dependence on supporting goals on the achievement of a goal in at least a plurality of individuals within the enterprise; and
fourth means for modifying the application of said personal incentives, said relationship incentives, and said community values in response to results deriving from said structurally monitoring and measuring steps.
